(19) United States
(12) Patent Application Publication
(10) Pub. No.: US 2010/0277464 A1
(43) Pub. Date: Nov. 4, 2010

(54) PLASMA DISPLAY DEVICE AND DRIVING METHOD THEREOF

(76) Inventor: Sang-Gu Lee, Suwon-si (KR)

Correspondence Address: CHRISTIE, PARKER & HALE, LLP, PO BOX 7068, PASADENA, CA, 91109-7068, US

(21) Appl. No.: 12/729,119

(22) Filed: Mar. 22, 2010

Related U.S. Application Data
(60) Provisional application No. 61/174,410, filed on Apr. 30, 2009.

(51) Int. Cl. G06F 3/038

(52) U.S. Cl. 345/213; 345/60

(57) ABSTRACT

A plasma display device includes: a plasma display panel having a first electrode and a second electrode crossing the first electrode; a first driver for driving the first electrode; and a second driver for driving the second electrode and including a first switch and a second switch coupled in series between a first voltage source and the second electrode. The first switch is configured to turn on while the second switch is configured to turn off to increase a voltage level of the second electrode during a first portion of a reset period. The first switch and the second switch are configured to both concurrently turn on to further increase the voltage level of the second electrode during a second portion of the reset period. A connection between the first switch and the second switch is coupled to a second voltage source for applying the connection with a second voltage.

### CROSS-REFERENCE TO RELATED APPLICATION(S)

This application claim priority to and the benefit of U.S. Provisional Patent Application No. 61/174,410, filed on Apr. 30, 2009, the entire content of which is incorporated herein by reference.

### BACKGROUND

(a) Field of the Invention

The following description relates to a plasma display device and a driving method thereof.

(b) Description of the Related Art

A plasma display device includes a plurality of display electrodes and a plurality of discharge cells defined by the plurality of display electrodes. In order to display images, the discharge cells to be turned on (hereinafter referred to as “on cells”) and the discharge cells to be turned off (hereinafter referred to as “off cells”) are selected from the plurality of discharge cells, and the on cells are discharged to display the images.

With the above-described plasma display device, before the selection of the on cells or the off cells, the voltage of the display electrodes gradually increases such that a weak discharge occurs in the discharge cells, and the charged state of the discharge cells is reset through the weak discharge. In order to gradually increase the voltage of the display electrodes, the on and off operations of the transistors connected to the display electrodes are repeated, or the current flowing to the gate of the transistors is controlled.

However, when the voltage of the display electrodes gradually increases, the current flows to the capacitor component formed by the display electrodes via the transistors. Therefore, power consumption continuously occurs at the transistors due to the current, and accordingly, heat generation of the transistors increases. A large heat sink is attached to the transistors to dissipate the generated heat, and consequently, the thickness of the plasma display device is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of embodiments of the present invention are directed toward a plasma display device and a driving method thereof with reduced heat generation from transistors included in the plasma display device.

According to an embodiment of the present invention, a plasma display device is provided. The plasma display device includes: a plasma display panel having a first electrode and a second electrode crossing the first electrode; a first driver for driving the first electrode; and a second driver for driving the second electrode and including a first switch and a second switch coupled in series between a first voltage source and the second electrode. The first switch is configured to turn on while the second switch is configured to turn off to increase a voltage level of the second electrode during a first portion of a reset period. Further, the first switch and the second switch are configured to both concurrently turn on to further increase the voltage level of the second electrode during a second portion of the reset period, and a connection between the first switch and the second switch is coupled to a second voltage source for applying the connection with a second voltage.

According to another embodiment of the present invention, a method of driving a plasma display device is provided. The plasma display device includes a plasma display panel having a first electrode and a second electrode crossing the first electrode, a driver for driving the second electrode, the driver including a first switch and a second switch coupled in series between a first voltage source and the second electrode, wherein a connection between the first switch and the second switch is coupled to a second voltage source for applying a second voltage. In a reset period, the method includes: increasing a voltage level of the second electrode from a start voltage to a voltage equal to a sum of the start voltage and the second voltage by turning on the first switch during a first portion of the reset period, and increasing the voltage level of the second electrode from the voltage equal to the sum of the start voltage and the second voltage to a voltage equal to a sum of the start voltage and the first voltage by concurrently turning on the first switch and the second switch during a second portion of the reset period.

According to another embodiment of the present invention, a plasma display device is provided. The plasma display device includes: a plasma display panel having a first electrode and a second electrode crossing the first electrode, and a driver for driving the second electrode. Further, the driver includes: a first switch coupled between the second electrode and a first voltage source for applying a first voltage, and a second switch coupled between the second electrode and a second voltage source. The second voltage source is for applying a second voltage lower in voltage level than the first voltage. The first switch is configured to decrease a voltage level of the second electrode from the first voltage to a third voltage having a voltage level between the second voltage and the first voltage during a first portion of the reset period, and the second switch is configured to further decrease the voltage level of the second electrode from the third voltage to the second voltage during a second portion of the reset period.

### BRIEF DESCRIPTION OF THE DRAWINGS

FIG. 1 is a schematic block diagram of a plasma display device according to an exemplary embodiment of the present invention.

FIG. 2 is a schematic timing diagram of driving waveforms of a plasma display device according to an exemplary embodiment of the present invention.

FIG. 3 is a schematic circuit diagram of a rising reset driving circuit of a plasma display device according to an exemplary embodiment of the present invention.

FIG. 4 and FIG. 5 are diagrams illustrating the voltages of a rising reset driving circuit according to an exemplary embodiment of the present invention.

FIG. 6 is a schematic circuit diagram of a scan electrode driver according to an exemplary embodiment of the present invention.

FIG. 7 is a schematic circuit diagram of a falling reset driving circuit according to an exemplary embodiment of the present invention.

FIG. 8 is a diagram illustrating the voltages of a falling reset driving circuit according to an exemplary embodiment of the present invention.

FIG. 9 and FIG. 10 are schematic circuit diagrams of a falling reset driving circuit according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “connected” or “coupled” to another element, the element may be “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements.

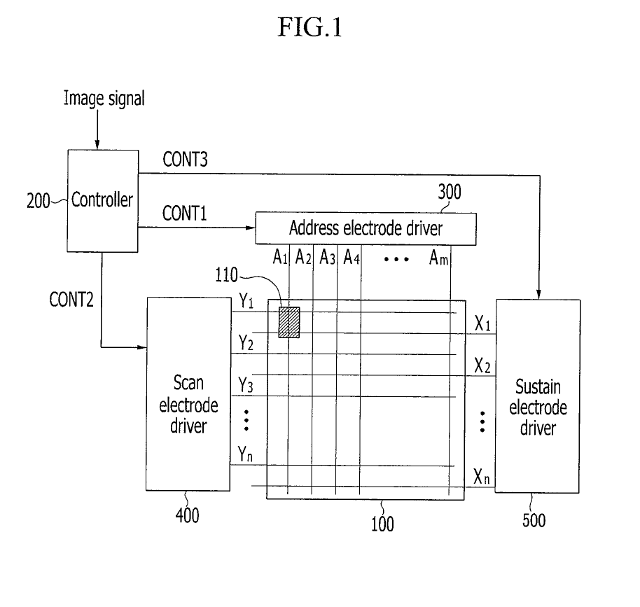

FIG. 1 is a schematic diagram of a plasma display device according to an exemplary embodiment of the present invention.

Referring to FIG. 1, the plasma display device includes a plasma display panel 100, a controller 200, an address electrode driver 300, a scan electrode driver 400, and a sustain electrode driver 500.

The plasma display panel 100 includes a plurality of display electrodes Y1 to Yn and X1 to Xn, a plurality of address electrodes (hereinafter referred to as “A electrodes”) A1 to Am, and a plurality of discharge cells defined by the display electrodes and the address electrodes.

The plurality of display electrodes Y1 to Yn are scan electrodes (hereinafter referred to as “Y electrodes”), and the plurality of display electrodes X1 to Xn are sustain electrodes (hereinafter referred to as “X electrodes”). The Y electrodes Y1 to Yn and the X electrodes X1 to Xn extend in the row direction while being substantially parallel to each other, and the A electrodes A1 to Am extend in the column direction while being substantially parallel to each other. The Y electrodes Y1 to Yn and the X electrodes X1 to Xn may have a one-to-one correspondence with each other. Alternatively, two of the X electrodes X1 to Xn may correspond to one of the Y electrodes Y1 to Yn, or one of the X electrodes X1 to Xn may correspond to two of the Y electrodes Y1 to Yn. Discharge cells 110 are formed at the spatial domains (e.g., crossing regions) defined by the A electrodes A1 to Am, the Y electrodes Y1 to Yn, and the X electrodes X1 to Xn.

The above-described structure is only an exemplary structure of the plasma display panel 100, which may be embodied in another structure according to another exemplary embodiment of the present invention.

The controller 200 receives image signals and input control signals for controlling the displaying thereof. The image signals contain luminance information of the respective discharge cells 110, and the luminance of the respective discharge cells 110 may be expressed by one of a predetermined or set number of grays or gray levels. The input control signals include a vertical synchronization signal, a horizontal synchronization signal, etc.

The controller 200 divides an image display frame into a plurality of sub-fields each with a luminance weight value such that at least one of the sub-fields includes a reset period, an address period, and a sustain period. The controller 200 processes the image signals and the input control signals appropriately for the plurality of sub-fields, and generates an A electrode driving control signal CONT1, a Y electrode driving control signal CONT2, and an X electrode driving control signal CONT3. The controller 200 outputs the A electrode driving control signal CONT1 to the address electrode driver 300 and outputs the Y electrode driving control signal CONT2 to the scan electrode driver 400, while outputting the X electrode driving control signal CONT3 to the sustain electrode driver 500.

Furthermore, the controller 200 converts the input image signal corresponding to the respective discharge cells 110 into sub-field data expressing the emission or non-emission of the respective discharge cells 110 in the plurality of sub-fields, and the A electrode driving control signal CONT1 includes the sub-field data.

During the address period, the scan electrode driver 400 sequentially applies the scan voltage to the Y electrodes Y1 to Yn in accordance with the Y electrode driving control signal CONT2. The address electrode driver 300 applies the voltage for discriminating or selecting the on and off cells from the plurality of discharge cells 110, which are connected to the scan voltage-applied Y electrodes, to the A electrodes A1 to Am in accordance with the A electrode driving control signal CONT1.

After the on and off cells are selected during the address period, the scan electrode driver 400 and the sustain electrode driver 500 alternately apply the sustain discharge pulses numbered corresponding to the luminance weight value of the respective sub-fields to the Y electrodes Y1 to Yn and the X electrodes X1 to Xn in accordance with the Y electrode driving control signal CONT2 and the X electrode driving control signal CONT3.

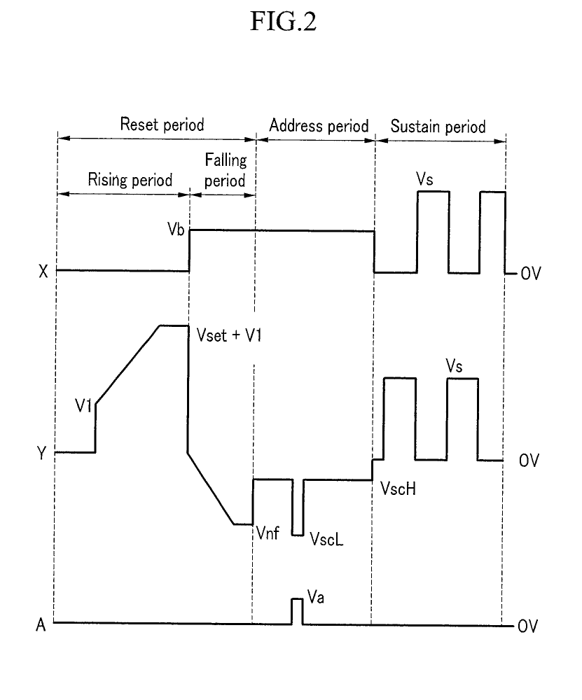

FIG. 2 is a schematic timing diagram of driving waveforms of a plasma display device according to an exemplary embodiment of the present invention.

FIG. 2 illustrates only one of the plurality of sub-fields, for better understanding and ease of description, and only the driving waveforms applied to the Y electrode, the X electrode, and the A electrode, which form one discharge cell, will be described.

Referring to FIG. 2, when the address electrode driver 300 and the sustain electrode driver 500 apply a predetermined voltage (e.g., a ground voltage in FIG. 2) to the A electrode and the X electrode, respectively, during a rising period of the reset period, the scan electrode driver 400 gradually increases the voltage of the Y electrode from the V1 voltage to the sum V1+Vset of the V1 and the Vset voltages, and then the voltage of the Y electrode is maintained at the V1+Vset voltage for a predetermined or set period of time. For example, the scan electrode driver 400 may gradually increase the voltage of the Y electrode, for example, by a ramp pattern with a suitable slope or inclination. As the voltage of the Y electrode gradually increases, weak discharge occurs between the Y and the A electrodes as well as between the Y and the X electrodes, and accordingly, negative charges are formed at the Y electrode while positive charges are formed at the X and A electrodes. In the embodiment of FIG. 2, the V1 voltage may be equal to a voltage difference VscH−VscL between the VscH and VscL voltages to be described below.

Thereafter, during a falling period of the reset period, when the address electrode driver 300 and the sustain electrode driver 500 apply the ground voltage and the Vb voltage to the A and the X electrodes respectively, the scan electrode driver 400 gradually decreases the voltage of the Y electrode from the ground voltage to the Vnf voltage. For example, the scan electrode driver 400 may gradually decrease the voltage of the Y electrode, for example, by a ramp pattern with a suitable slope or inclination. When the voltage of the Y electrode gradually decreases, weak discharge occurs between the Y and A electrodes as well as between the Y and X electrodes, and accordingly, the negative charges formed at the Y electrode and the positive charges formed at the X and A electrodes during the rising period are erased. As described above, the discharge cell 110 may be reset. Here, the Vnf voltage may be established to be a negative voltage, and the Vb voltage may be established to be a positive voltage. Furthermore, the voltage difference Vb−Vnf between the Vb and Vnf voltages is established to be substantially equal to the discharge firing voltage between the Y and X electrodes so that the reset discharge cell may become the off cell. During the falling period, the voltage of the Y electrode may gradually decrease from a voltage other than the ground voltage.

During the address period, in order to discriminate the on and off cells from each other, when the sustain electrode driver 500 applies the Vb voltage to the X electrodes, the scan electrode driver 400 applies the scan pulse with the VscL voltage (the scan voltage) to the plurality of scan electrodes Y1-Yn shown in FIG. 1 either in a progressive order or in an interlace order. At the same time, the address electrode driver 300 applies the Va voltage (the address voltage) to the A electrodes passing through the on cells of the plurality of discharge cells formed by the VscL voltage-applied Y electrodes. Accordingly, the address discharge occurs at the discharge cell formed by the Va voltage-applied A electrode and the VscL voltage-applied Y electrode so that positive charges are formed at the Y electrode, and negative charges are formed at the A and X electrodes, respectively. Furthermore, the scan electrode driver 400 apply the VscH voltage (the non-scan voltage) that is higher than the VscL voltage to the Y electrode not applied with the VscL voltage, and the address electrode driver 300 apply the ground voltage to the A electrode not applied with the Va voltage. In the embodiment of FIG. 2, the VscL voltage may be a negative voltage and the Va voltage may be a positive voltage.

In addition, it is described above that wall charges are erased from the discharge cells during the reset period so as to generate the reset, and wall charges are formed at the discharge cells through the address discharge to thereby select the on cells. Alternatively, the wall charges of the discharge cells may be erased through the address discharge so as to select the off cells. In another embodiment, wall charges are formed at the discharge cells during the reset period so as to generate the reset. In another embodiment, the off cells are selected from the discharge cells that were the on cells in an immediately previous sub-field, without any reset period.

During the sustain period, the scan electrode driver 400 and the sustain electrode driver 500 alternately apply sustain discharge pulses with a high voltage Vs and a low voltage (for example, a ground voltage) to the Y and X electrodes, respectively, such that they are opposite in phase to each other. That is, when the high voltage Vs is applied to the Y electrode while the low voltage is applied to the X electrode, sustain discharge is generated at the on cells due to the voltage difference between the high voltage Vs and the low voltage. Thereafter, when the low voltage is applied to the Y electrode and the high voltage Vs is applied to the X electrode, the sustain discharge is again generated at the on cells due to the voltage difference between the high voltage Vs and the low voltage. This operation is repeated during the sustain period so that the sustain discharges numbered corresponding to the luminance weight value of the relevant sub-field are generated. Alternatively, the high voltage of the sustain discharge pulse may be established to be a Vs/2 voltage, and the low voltage of the sustain discharge pulse to be a −Vs/2 voltage. Furthermore, when a ground voltage is applied to one of the Y and X electrodes (for example, the X electrode), the sustain pulses alternately having the Vs voltage and the −Vs voltage may be applied to the other electrode (for example, the Y electrode).

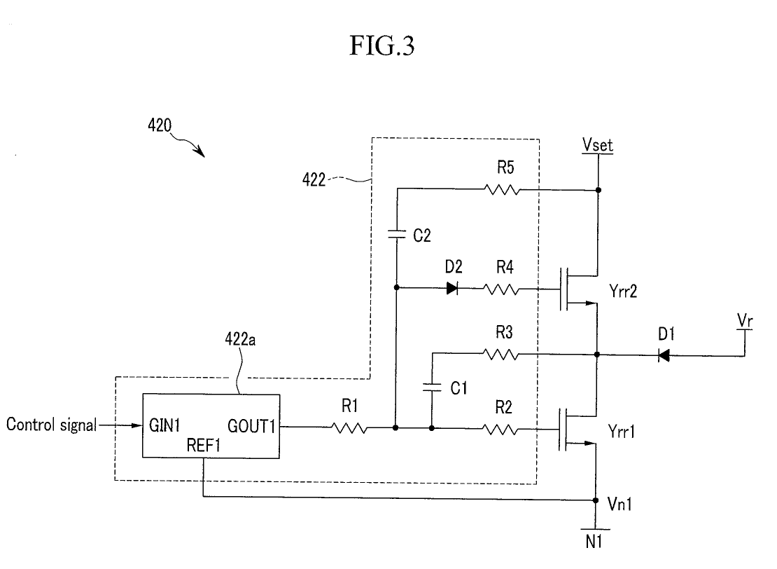

FIG. 3 is a schematic circuit diagram of a rising reset driving circuit of a plasma display device according to an exemplary embodiment of the present invention.

Referring to FIG. 3, the rising reset driving circuit 420 includes transistors Yrr1 and Yrr2, a rising reset controller 422, and a current interruption element D1.

The transistors Yrr1 and Yrr2 are each a switch having a control terminal, an input terminal, and an output terminal. It is illustrated in FIG. 3 that the transistors Yrr1 and Yrr2 are N-channel field effect transistors (FET), and in FIG. 3, the control terminal, the input terminal, and the output terminal thereof become a gate, a drain, and a source, respectively. Body diodes may be formed at the transistors Yrr1 and Yrr2, respectively. The anodes of the body diodes may be connected to the sources of the transistors Yrr1 and Yrr2, respectively, while the cathodes thereof are connected to the drains of the transistors Yrr1 and Yrr2, respectively.

The source of the transistor Yrr1 is connected to a node N1, and the drain thereof is connected to a power supply Vr for supplying a Vr voltage. The source of the transistor Yrr2 is connected to the drain of the transistor Yrr1, and the drain thereof is connected to a power supply Vset for supplying a Vset voltage that is higher than the Vr voltage. That is, the two transistors Yrr2 and Yrr1 are connected in series between the power supply Vset and the node N1. The node N1 is connected to the Y electrode. One or more elements may be connected between the node N1 and the Y electrode, which are used in operating the plasma display device. The Y electrode forms a capacitive component (hereinafter referred to as the “panel capacitor”) together with the X electrode and/or the A electrode.

When the source voltage of the transistor Yrr1 is lower than the Vr voltage, the rising reset controller 422 operates the transistor Yrr1 while the transistor Yrr2 is turned off. Then, the transistor Yrr1 supplies a current from the power supply Vr to the Y electrode by way of the control of the rising reset controller 422 such that the voltage of the Y electrode gradually increases. When the source voltage of the transistor Yrr1 is higher than the Vr voltage, the rising reset controller 422 operates the two transistors Yrr1 and Yrr2 concurrently. Then, the two transistors Yrr1 and Yrr2 supply the current from the power supply Vset to the Y electrode by way of the control of the rising reset controller 422 such that the voltage of the Y electrode gradually increases.

The current interruption element D1 is connected between the source of the transistor Yrr2 (that is, the drain of the transistor Yrr1) and the power supply Vr, and interrupts a current path flowing from the source of the transistor Yrr1 to the power supply Vr. As shown in FIG. 3, a diode with a cathode connected to the source of the transistor Yrr2 and an anode connected to the power supply Vr may be used as the current interruption element D1 according to an embodiment of the present invention. Alternatively, a transistor may be used as the current interruption element D1.

In FIG. 3, the rising reset controller 422 includes capacitors C1 and C2, a resistor R1, and a gate driver 422a.

The gate driver 422a includes a reference voltage terminal REF1, an input terminal GIN1, and an output terminal GOUT1, and the reference voltage terminal REF1 is connected to the source of the transistor Yrr1 so as to determine the reference voltage of the gate driver 422a. The gate driver 422a is operated by a control signal input into the input terminal GIN1, and outputs a gate signal through the output terminal GOUT1. When the gate driver 422a receives the control signal for the operation during the rising period of the reset period through the input terminal GIN1, it sets the voltage of the gate signal be higher than the voltage of the reference voltage terminal REF1, that is, the source voltage Vn1 of the transistor Yrr1.

The capacitor C1 is connected between the output terminal GOUT1 of the gate driver 422a and the drain of the transistor Yrr1, and the capacitor C2 is connected between the output terminal GOUT1 of the gate driver 422a and the drain of the transistor Yrr2. The resistor R1 is connected between the output terminal GOUT1 of the gate driver 422a and the contact point (or node) between the two capacitors C1 and C2.

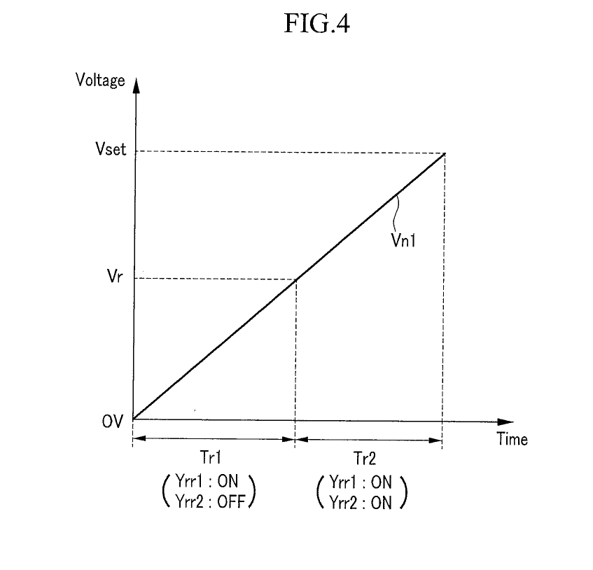

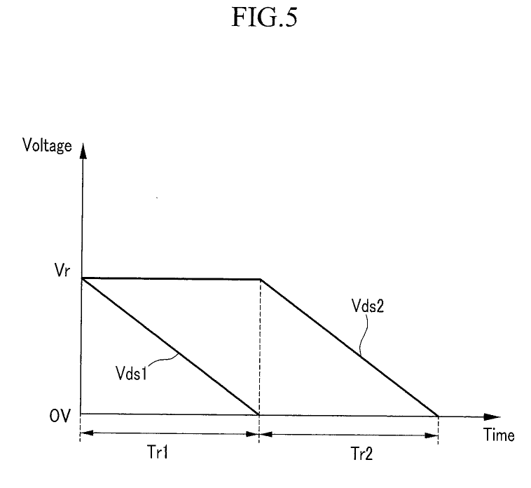

The operation of the rising reset driving circuit 420 will be described in more detail with reference to FIG. 4 and FIG. 5.

FIG. 4 and FIG. 5 illustrate the voltages of the rising reset driving circuit 420 according to an exemplary embodiment of the present invention.

For better understanding and ease of description, the threshold voltage Vth of the two transistors Yrr1 and Yrr2 will be assumed to be the same, and the source voltage of the transistor Yrr1 just before the operation of the rising reset driving circuit 420 is assumed to be 0V.

First, the gate driver 422a increases the voltage of the gate signal (i.e., voltage at GOUT1) to operate the rising reset driving circuit 420 in response to the control signal input into the input terminal GIN1. Then, the gate voltage Vg of each of the transistors Yrr1 and Yrr2 increases in the pattern of an RC circuit by way of the resistor R1 and the capacitors C1 and C2.

Accordingly, when the gate voltage Vg of the transistor Yrr1 increases from the source voltage Vn1 by as much as the threshold voltage Vth of the transistor Yrr1, the voltage between the gate and source of the transistor Yrr1 (hereinafter referred to as the “gate-source voltage”) exceeds the threshold voltage Vth so that the transistor Yrr1 turns on. However, as the gate voltage Vg of the transistor Yrr2 is lower than the source voltage of the transistor Yrr2, that is, the Vr voltage, the transistor Yrr2 is maintained in a turned-off state.

When the transistor Yrr1 turns on, a current is supplied from the power supply Vr (and/or the capacitor C1) to the Y electrode via the transistor Yrr1 so that the voltage of the Y electrode increases, and accordingly, the source voltage Vn1 of the transistor Yrr1 increases. Here, as the gate voltage Vg of the transistor Yrr1 is maintained to be constant by way of the capacitor C1, the gate-source voltage of the transistor Yrr1 decreases so that the transistor Yrr1 turns off when its gate-source voltage becomes lower than its threshold voltage Vth.

When the transistor Yrr1 turns off, the gate voltage Vg again increases in the RC pattern by way of the gate signal from the gate driver 422a. Accordingly, when the gate-source voltage of the transistor Yrr1 exceeds the threshold voltage Vth, the transistor Yrr1 again turns on.

Then, as described above, the process where the voltage of the Y electrode increases by way of the turning on of the transistor Yrr1, the process where the transistor Yrr1 turns off as the voltage of the Y electrode increases and the process where the transistor Yrr1 again turns on after the turning off of the transistor Yrr1 are repeated. When the above processes are repeated, the gate-source voltage of the transistor Yrr1 rises slightly over the threshold voltage Vth of the transistor Yrr1, and again falls slightly so that it is substantially maintained to be around the threshold voltage Vth of the transistor Yrr1. Accordingly, a minute current flows through the transistor Yrr1, and the voltage of the Y electrode gradually increases by the ramp pattern due to the minute current flow.

Then, as shown in FIG. 4, during a first rising period Tr1, the transistor Yrr1 repeatedly turns on and off while the transistor Yrr2 turns off until the source voltage Vn1 of the transistor Yrr1 equals the Vr voltage. During the first rising period Tr1, the drain voltage of the transistor Yrr1 is maintained at the Vr voltage.

When the source voltage Vn1 of the transistor Yrr1 increases up to the Vr voltage by way of the voltage increase of the Y electrode, the drain voltage of the transistor Yrr1, that is, the source voltage of the transistor Yrr2, equals the source voltage Vn1 of the transistor Yrr1 by way of the turning on of the transistor Yrr1. Then, in a second rising period Tr2, when the gate voltage Vg increases from the source voltage Vn1 of the transistor Yrr1 by as much as the threshold voltage Vth, as shown in FIG. 4, the two transistors Yrr1 and Yrr2 begin to simultaneously or concurrently turn on.

Even during the second rising period Tr2, as described earlier, while the gate voltage Vg is substantially equal to the sum of the source voltage Vn1 and the threshold voltage Vth, the two transistors Yrr1 and Yrr2 repeatedly turn on and off. Accordingly, the source voltage Vn1 of the transistor Yrr1 gradually increases up to the Vset voltage by the ramp pattern, and as a result, the voltage of the Y electrode gradually increases in accordance with the ramp pattern.

Referring to FIG. 3 again, in order to determine the inclination or the slope of the ramp pattern by which the voltage of the Y electrode gradually increases, a resistor R2 may be connected between the resistor R1 and the gate of the transistor Yrr1, and a resistor R3 may be connected to the capacitor C1 in series between the gate and drain of the transistor Yrr1. Similarly, a resistor R4 may be connected between the resistor R1 and the gate of the transistor Yrr2, and a resistor R5 may be connected to the capacitor C2 in series between the gate and drain of the transistor Yrr2.

In addition, during the first rising period Tr1, the drain voltage of the transistor Yrr1 is maintained at the Vr voltage, and the source voltage Vn1 of the transistor Yrr1 gradually increases from 0V to the Vr voltage. Therefore, as shown in FIG. 5, during the first rising period Tr1, the voltage Vds1 between the drain and source (hereinafter referred to as the “drain-source voltage”) of the transistor Yrr1 gradually decreases from the Vr voltage to 0V, and the drain-source voltage Vds2 of the transistor Yrr2 is maintained at the Vset−Vr voltage. For better understanding and ease of description, it is shown in FIG. 5 that the Vset voltage is double the Vr voltage.

During the second rising period Tr2, the drain voltage of the transistor Yrr1, that is, the source voltage of the transistor Yrr2, is established to be the same as the source voltage Vn1 of the transistor Yrr1, and the drain voltage of the transistor Yrr2 is maintained at the Vset voltage. Therefore, during the second rising period T2, the drain-source voltage Vds1 of the transistor Yrr1 is 0V, and the drain-source voltage Vds2 of the transistor Yrr2 gradually decreases from the Vset−Vr voltage (i.e., Vr voltage in FIG. 5) to 0V. During the first rising period Tr1, as the transistor Yrr2 remains turned off, power is consumed through the transistor Yrr1. When the capacitance of the panel capacitor is indicated by Cp, the power P1 is given by way of Equation 1. During the second rising period T2, as the drain-source voltage of the transistor Yrr1 is 0V, power is consumed through the transistor Yrr2. The power P2 is given by way of Equation 2. The power P3 consumed through the two transistors Yrr1 and Yrr2 during the rising period of the reset period is given by way of Equation 3.

P1=½*Cp*(Vr)² [Equation 1]

P2=½*Cp*(Vset−Vr)² [Equation 2]

P3=P1+P2=½*Cp*{(Vset)²−2*Vr*(Vset−Vr)} [Equation 3]

In contrast, differing from the above described exemplary embodiment of the present invention, in a plasma display device where the voltage of the Y electrode gradually increases by way of one transistor, the drain-source voltage of the transistor gradually decreases from the Vset voltage to 0V. Therefore, the power P4 consumed through the transistor is given by Equation 4, and the P4 power is always greater than the P3 power consumed through the two transistors Yrr1 and Yrr2 of the embodiment shown in FIG. 3.

P4=½*Cp*(Vset)²>P3 [Equation 4]

In one embodiment, when the Vr voltage is half the Vset voltage, the P3 power is half the P4 power. As the powers P1 and P2 consumed at the respective transistors Yrr1 and Yrr2 are each a quarter (¼) of the P4 power, the heat generation of the respective transistors Yrr1 and Yrr2 may also decrease to be a quarter of the heat generation from the one transistor. As the heat generation of the transistors Yrr1 and Yrr2 is lower, the heat sink to be attached to the transistors Yrr1 and Yrr2 may be thinner or even omitted in some embodiments, and accordingly, the thickness of the plasma display device may be reduced.

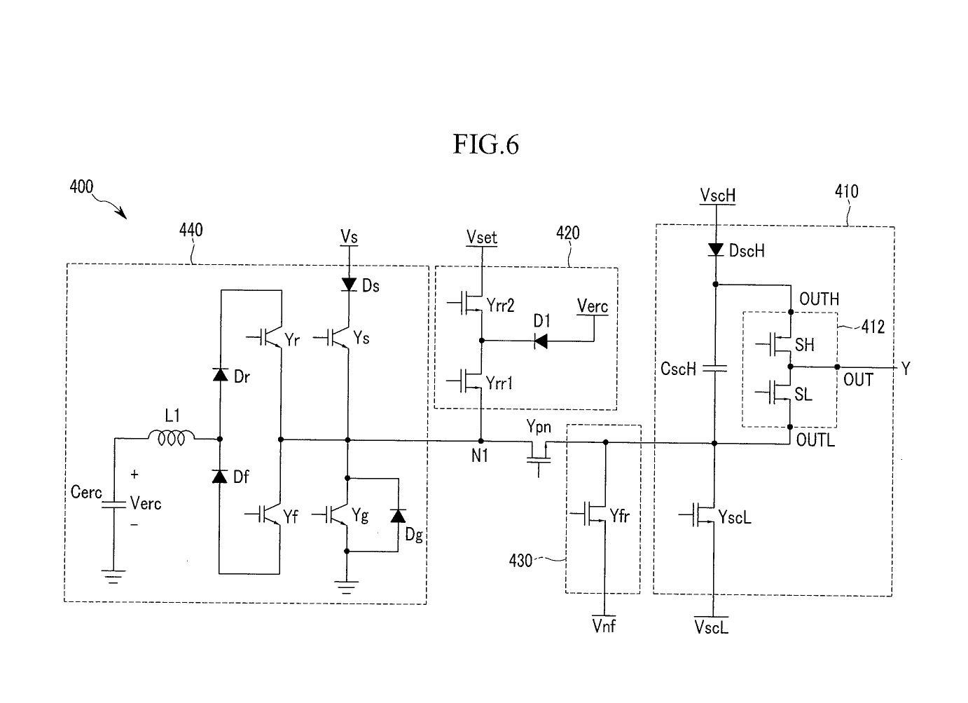

A scan electrode driver 400 according to an exemplary embodiment of the present invention will now be described with reference to FIG. 6.

FIG. 6 is a schematic circuit diagram of the scan electrode driver 400 according to an exemplary embodiment of the present invention.

Referring to FIG. 6, the scan electrode driver 400 includes a scan driver 410, a rising reset driver 420, a falling reset driver 430, and a sustain driver 440.

The scan driver 410 includes a scan circuit 412, a capacitor CscH, and a transistor YscL, and the scan circuit 412 includes a high voltage terminal OUTH, a low voltage terminal OUTL, and an output terminal OUT. Furthermore, the scan circuit 412 may include two transistors SH and SL.

The rising reset driver 420 corresponds to the rising reset driving circuit 420 shown in FIG. 3.

The falling reset driver 430 includes a transistor Yfr.

The sustain driver 440 includes transistors Ys, Yg, Yr, and Yf, an inductor L1, and a capacitor Cerc.

In FIG. 6, the transistors Ys, Yg, Yr, Yf, YscL, Yfr, Yrr1, Yrr2, SH, and SL are each a switch having a control terminal, an input terminal, and an output terminal. With the exemplary embodiment shown in FIG. 6, the transistors Ys, Yg, Yr, and Yf are exemplified as insulated gate bipolar transistors (IGBT), and in FIG. 6, the control terminal, the input terminal, and the output terminal thereof correspond to a gate, a collector, and an emitter, respectively. Furthermore, the transistors YscL, Yfr, Yrr1, Yrr2, and SL are exemplified as N-channel field effect transistors (FET), and in FIG. 6, the control terminal, the input terminal, and the output terminal thereof correspond to a gate, a drain, and a source, respectively. The transistor SH is exemplified as a P-channel field effect transistor, and in FIG. 6, the control terminal, the input terminal, and the output terminal thereof correspond to a gate, a source, and a drain, respectively. The field effect transistors YscL, Yfr, Yrr1, Yrr2, SH and SL may each be provided with a body diode.

In FIG. 6, with the scan driver 410, the drain of the transistor YscL is connected to the low voltage terminal OUTL, and the source thereof is connected to a power supply VscL for supplying a VscL voltage. The capacitor CscH is connected between the high and low voltage terminals OUTH and OUTL of the scan circuit 412, and the power supply VscH for supplying the VscH voltage is connected to the high voltage terminal OUTH of the scan circuit 412. In FIG. 6, a diode DscH may be connected between the power supply VscH and the high voltage terminal OUTH of the scan circuit 412 in order to interrupt the current flow from the capacitor CscH to the power supply VscH. When the transistor YscL turns on, the capacitor CscH is charged with the VscH−VscL voltage corresponding to the difference between the VscH and the VscL voltages.

As to the transistor SH of the scan circuit 412, its source is connected to the high voltage terminal OUTH, and its drain is connected to the output terminal OUT. As to the transistor SL, its drain is connected to the output terminal OUT, and its source is connected to the low voltage terminal OUTL. Depending upon the turning on or off of the transistors SH and SL, the scan circuit 412 establishes the voltage of the Y electrode to be the voltage of the high voltage terminal OUTH or the voltage of the low voltage terminal OUTL.

The scan circuit 412 may correspond to the Y electrode one by one, and a plurality of scan circuits may be formed at the scan driver 410 such that they correspond to a plurality of Y electrodes (Y1 to Yn of FIG. 1). In this case, some of the plurality of scan circuits may be formed as an integrated circuit (IC) while sharing the high and low voltage terminals OUTH and OUTL.

During the address period, the transistor YscL turns on, and the voltage of the low voltage terminal OUTL of the scan circuit 412 becomes the VscL voltage. The transistors SLs of the plurality of scan circuits 412 sequentially turn on so that the plurality of scan circuits 412 sequentially apply the voltage VscL of the low voltage terminal OUTL to the plurality of Y electrodes. As to the respective scan circuits 412 where the transistor SL does not turn on, the transistor SH turns on so as to apply the voltage VscH of the high voltage terminal OUTH to the Y electrode connected thereto.

As to the rising reset driver 420, a node N1, to which the source of the transistor Yrr1 is connected, is connected to the low voltage terminal OUTL of the scan circuit 412, that is, to a terminal of the capacitor CscH. During the rising period of the reset period, when a ground voltage is applied to the Y electrode, the transistor SL of the scan circuit 412 turns off, and the transistor SH thereof turns on. Then, the VscH−VscL voltage is applied to the Y electrode due to the voltage charged at the capacitor CscH. Thereafter, as the source voltage of the transistor Yrr1 gradually increases from 0V to the Vset voltage by way of the operation of the rising reset driver 420, the voltage of the Y electrode gradually decreases from the VscH−VscL voltage to the Vset+VscH−VscL voltage by way of the capacitor CscH. In this embodiment, the V1 voltage shown in FIG. 2 corresponds to the VscH−VscL voltage.

As to the falling reset driver 430, the drain of the transistor Yfr is connected to the Y electrode via the low voltage terminal OUTL of the scan circuit 412, and the source thereof to a power supply VnF for supplying a Vnf voltage. The transistor Yfr operates by way of a falling reset controller connected to the gate thereof such that the voltage of the Y electrode gradually decreases, and accordingly, the voltage of the Y electrode is gradually reduced to the Vnf voltage.

Then, as to the sustain driver 440, the collector of the Ys transistor is connected to a power supply for supplying a high voltage Vs of the sustain discharge pulse, and the emitter thereof is connected to the Y electrode via the low voltage terminal OUTL of the scan circuit 412. The Ys transistor turns on when the high voltage Vs of the sustain discharge pulse is applied to the Y electrode during the sustain period. The collector of the Yg transistor is connected to the Y electrode via the low voltage terminal OUTL of the scan circuit 412, and the emitter thereof is connected to a power supply for supplying a low voltage of the sustain discharge pulse, for example, to a ground terminal. The Yg transistor turns on when the low voltage of the sustain discharge pulse is applied to the Y electrode during the sustain period and when a ground voltage is applied to the Y electrode during the reset period.

The emitter of the transistor Yr and the collector of the transistor Yf are connected to the Y electrode via the low voltage terminal OUTL of the scan circuit 412, and the collector of the transistor Yr and the emitter of the transistor Yf are connected to a terminal of the inductor L1. The other terminal of the inductor L1 is connected to a terminal of a power collection capacitor Cerc, and the other terminal of the capacitor Cerc is connected to a ground terminal. The voltage Verc charged at the capacitor Cerc is a voltage ranging between the high voltage Vs and the low voltage. For example, the Verc voltage may be a Vs/2 voltage, which is half the voltage difference between the high voltage Vs and the low voltage.

During the sustain period, the transistor Yr turns on before the Ys transistor turns on. With the turning on of the transistor Yr, a resonance is made between the inductor and the panel capacitor so that the panel capacitor is charged with the energy charged at the capacitor Cerc, and accordingly, the voltage of the Y electrode increases from 0V to the Vs voltage. During the sustain period, the transistor Yf turns on before the Yg transistor turns on. With the turning on of the transistor Yf, a resonance is made between the inductor and the panel capacitor so that the capacitor Cerc collects the energy discharged from the panel capacitor, and accordingly, the voltage of the Y electrode decreases from the Vs voltage to about 0V. In FIG. 6, a diode Dr may be connected to the transistor Yr in series in order to form a current path for charging the panel capacitor, and another diode Df may be connected to the transistor Yf in series in order to form a current path for discharging the panel capacitor.

Still another diode Dg may be connected to the Yg transistor in parallel in order to prevent or protect the voltage of a terminal of the inductor L1 from being lowered to be less than the ground voltage with the turning on of the transistor Yf. In addition, as the voltage of a terminal of the inductor L1 is prevented or protected from being increased to be more than the Vs voltage with the turning on of the transistor Yr by the formation of the body diodes of the Yrr1 and Yrr2 transistors. Still another diode Ds may be connected to the Ys transistor in series such that only the forward current from the power supply Vs flows to the Ys transistor.

Furthermore, as the Vnf or VscL voltage is a negative voltage, a transistor Ypn may be formed on the current flow route in order to prevent or protect the current from flowing from the ground terminal to the power supply Vnf or VscL via the Dg diode with the turning on of the Yfr or YscL transistor. That is, the drain of the transistor Ypn may be connected to the cathode of the Dg diode, and the source thereof may be connected to the drain of the YscL or Yfr transistor.

In addition, as to the scan electrode driver 400 shown in FIG. 6, in an embodiment in which the Vset voltage of the reset period is established to be the same as the Vs voltage of the sustain period, the power supply for supplying the Vset voltage may be omitted. Furthermore, in an embodiment in which the Vr voltage of the reset period is established to be the same as the Verc voltage charged at the capacitor Cerc, the power supply for supplying the Vr voltage may be omitted.

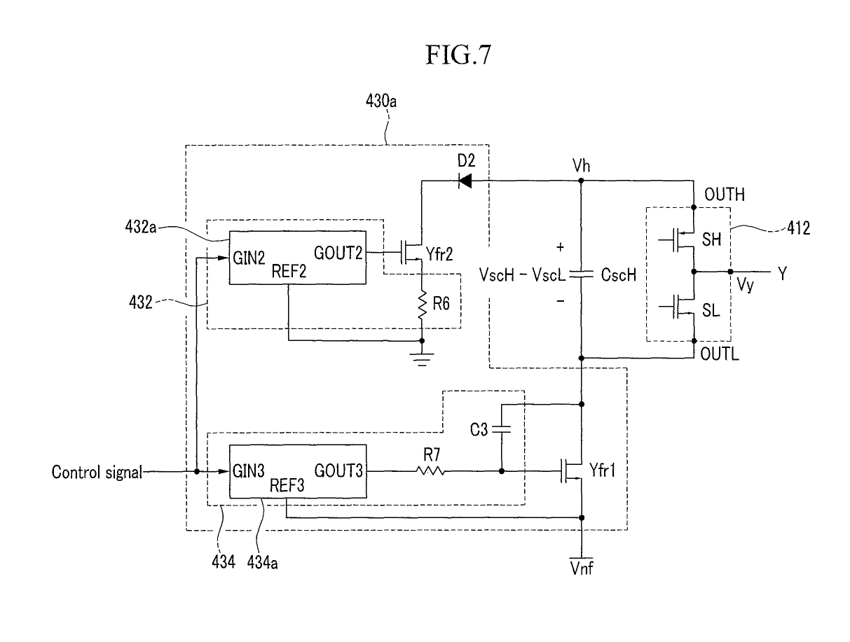

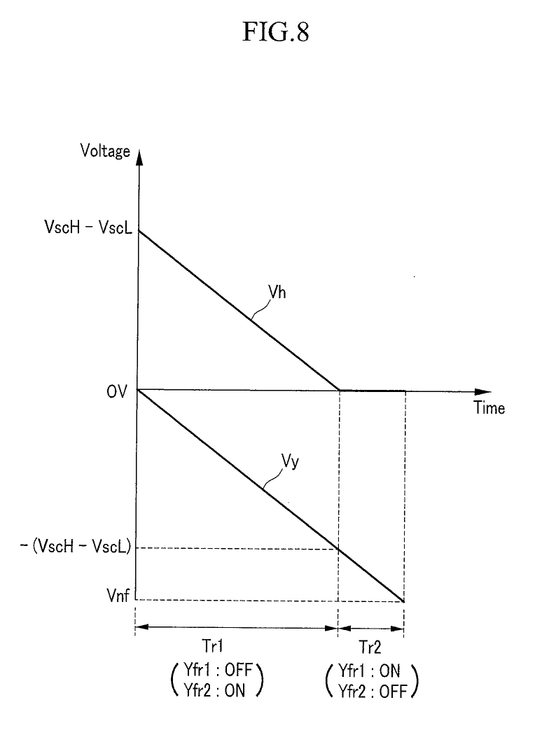

An exemplary embodiment of the present invention, where with the scan electrode driver 400 shown in FIG. 6, the heat generation of the transistor Yfr of the falling reset driver 430 is reduced, will now be described with reference to FIG. 7 and FIG. 8.

FIG. 7 is a schematic circuit diagram of a falling reset driving circuit according to an exemplary embodiment of the present invention, and FIG. 8 is a diagram illustrating the voltages of a falling reset driving circuit according to an exemplary embodiment of the present invention.

Referring to FIG. 7, the falling reset driving circuit 430a includes transistors Yfr1 and Yfr2, a current interruption element D2, and falling reset controllers 432 and 434.

The drain of the transistor Yfr1 is connected to the low voltage terminal OUTL of the scan circuit 412, and the source thereof is connected to a power supply Vnf. The drain of the transistor Yfr2 is connected to the high voltage terminal OUTH of the scan circuit 412, and the source thereof is connected to a predetermined voltage source, for example, to a ground terminal. As described in reference to FIG. 6, a capacitor CscH is connected between the high and low voltage terminals OUTH and OUTL of the scan circuit 412, and the capacitor CscH is charged with a VscH−VscL voltage.

The two falling reset controllers 432 and 434 operate upon receipt of the control signal for the operation during the falling period of the reset period. When the voltage of the high voltage terminal OUTH is higher than the ground voltage, the falling reset controller 432 gradually decreases the voltage of the Y electrode through the transistor Yfr2. Under the control of the falling reset controller 432, the transistor Yfr2 supplies the current from the high voltage terminal OUTH to the ground terminal such that the voltage of the high voltage terminal OUTH is gradually reduced to 0V. Then, the voltage of the Y electrode is gradually reduced to the −(VscH−VscL) voltage via the transistor SL, the capacitor CscH, and the transistor Yfr2 of the scan circuit 412, by way of the VscH−VscL voltage charged at the capacitor Csch. When the voltage of the high voltage terminal OUTH is lower than the ground voltage, the falling reset controller 434 gradually decreases the voltage of the Y electrode through the transistor Yfr1. The transistor Yfr1 supplies the current from the Y electrode to the power supply Vnf via the transistor SL of the scan circuit 412 such that the voltage of the Y electrode is gradually reduced to the Vnf voltage.

A current interruption element D2 is connected between the drain of the transistor Yfr2 and the high voltage terminal OUTH of the scan circuit 412, and when the voltage of the Y electrode is reduced to be less than the ground voltage, it interrupts the current flow passage from the ground terminal to the lower voltage terminal OUTL via the capacitor CscH and the transistor Yfr2. As shown in FIG. 7, a diode with a cathode connected to the drain of the transistor Yfr2 and an anode connected to the high voltage terminal OUTH may be used as the current interruption element D2. Alternatively, a transistor may be used as the current interruption element D2.

One of the falling reset controllers 432 includes a resistor R6 and a gate driver 432a, and the other falling reset controller 434 includes a capacitor C3, a resistor R7, and a gate driver 434a.

A first terminal of the resistor R6 is connected to the source of the transistor Yfr2, and a second terminal thereof is connected to the ground terminal. The gate driver 432a includes a reference voltage terminal REF2, an input terminal GIN2, and an output terminal GOUT2, and the reference voltage terminal REF2 is connected to the ground terminal so as to determine the reference voltage of the gate driver 432a. In addition, a resistor may be connected between the gate of the transistor Yfr2 and the output terminal GOUT2 of the gate driver 432a.

The gate driver 434a includes a reference voltage terminal REF3, an input terminal GIN3, and an output terminal GOUT3, and the reference voltage terminal REF3 is connected to the source of the transistor Yfr1 so as to determine the reference voltage of the gate driver 434a. The capacitor C3 is connected between the output terminal GOUT3 of the gate driver 434a and the drain of the transistor Yfr1, and the resistor R7 is connected between the output terminal GOUT3 and the capacitor C3 of the gate driver 434a.

The two gate drivers 432a and 434a operate by way of the control signal input into the input terminals GIN2 and GIN3 thereof, and output the gate signal through the output terminals GOUT2 and GOUT3, respectively. Upon receipt of the control signal for the operation during the falling period of the reset period through the input terminals GIN2 and GIN3, the two gate drivers 432a and 434a set the voltage of the gate signal higher than the voltage of the reference voltage terminals REF2 and REF3 so as to turn on the transistors Yfr1 and Yfr2.

The operation of the falling reset driving circuit 430 will now be described in more detail with reference to FIG. 8.

According to an embodiment, it will be assumed with reference to the driving waveforms shown in FIG. 2 that the voltage of the Y electrode is 0V just before the operation of the falling reset driving circuit 430. Then, the voltage Vh of the high voltage terminal OUTH of the scan circuit becomes a VscH−VscL voltage by way of the capacitor CscH.

First, the gate drivers 432a and 434a increase the voltage of the respective gate signals so as to operate the falling reset driving circuit 430 in response to the control signals input into the input terminals GIN2 and GIN3. Then, the gate voltage of the transistor Yfr1 increases in the RC pattern by way of the resistor R7 and the capacitor C3, and the gate voltage of the transistor Yfr2 is just elevated, differing from the RC pattern of the gate voltage of the transistor Yfr1. Accordingly, the gate-source voltage of the transistor Yfr2 exceeds its threshold voltage before the gate-source voltage of the transistor Yfr1 exceeds its threshold voltage.

When the gate-source voltage of the transistor Yfr2 exceeds its threshold voltage, the transistor Yfr2 turns on, and accordingly, the current flows from the Y electrode to the ground terminal via the transistor SL, the capacitor CscH, the transistor Yfr2, and the resistor R6. Then, as shown in FIG. 8, the voltage of the Y electrode decreases from 0V, and the voltage Vh of the high voltage terminal OUTH of the scan circuit 412 decreases from the VscH−VscL voltage. The voltage across the resistor R6 increases by way of the current flowing through the resistor R6. Then, the source voltage of the transistor Yfr2 increases so that the gate-source voltage of the transistor Yfr2 decreases, and accordingly, the transistor Yfr2 turns off.

When the transistor Yfr2 turns off, the gate voltage of the transistor Yfr2 again is increased by way of the gate signal from the gate driver 432a. Accordingly, when the gate-source voltage of the transistor Yfr2 exceeds its threshold voltage, the transistor Yfr2 again turns on.

Then, the process where the voltage of the Y electrode decreases by way of the turning on of the transistor Yfr2, the process where the transistor Yfr2 turns off by way of the voltage decrease of the Y electrode, and the process where the transistor Yfr2 again turns on after the turning off of the transistor Yfr2 are repeated. As those processes are repeated, the gate-source voltage of the transistor Yfr2 slightly rises over its threshold voltage and again slightly falls so that it is maintained around its threshold voltage. Accordingly, minute current flows through the transistor Yfr2, and the voltage Vy of the Y electrode and the high voltage terminal voltage Vh of the scan circuit 412 gradually decrease in the ramp pattern.

As shown in FIG. 8, in a first falling period Tf1, the transistor Yfr2 is continuously and repeatedly turned on and off until the high voltage terminal voltage Vh of the scan circuit 412 equals the voltage of the ground terminal, that is, 0V. In addition, during the first falling period Tf1, the gate voltage of the transistor Yfr1 is elevated by way of the gate signal, but when the voltage of the Y electrode decreases, the voltage charged at the capacitor C3 is also discharged through the transistor Yfr2. Therefore, the gate voltage of the transistor Yfr1 does not increase, practically due to the capacitor C3. Accordingly, during the first falling period Tf1, the transistor Yfr1 is substantially maintained in a turned-off state.

In addition, as the voltage Vh of the high voltage terminal OUTH is reduced to 0V by way of the falling of the Y electrode voltage Vy, the drain-source voltage of the transistor Yfr2 becomes 0V, and the transistor Yfr2 is maintained in a turned-off state. In FIGS. 7 and 8, the voltage of the Y electrode is reduced to the −(VscH−VscL) voltage by way of the capacitor CscH. The gate voltage of the transistor Yfr1 increases in the RC pattern by way of the gate signal of the gate driver 434a, and the second falling period Tf2 begins.

When the gate-source voltage of the transistor Yfr1 exceeds its threshold voltage due to its increased gate voltage, the transistor Yfr1 turns on. When the transistor Yfr1 turns on, a current is supplied from the Y electrode to the power supply Vnf via the two transistors SL and Yfr1 so that the voltage of the Y electrode is reduced, and accordingly, the drain voltage of the transistor Yfr1 is reduced. Then, as the gate voltage of the transistor Yfr1 is reduced due to the capacitor C3, the gate-source voltage of the transistor Yfr1 is reduced so that the transistor Yfr1 turns off.

When the transistor Yfr1 turns off, its gate voltage increases by way of the gate signal from the gate driver 434a, and again increases in the RC pattern. When the gate-source voltage of the transistor Yfr1 exceeds its threshold voltage, the transistor Yfr1 again turns on.

Then, as described above, the process where the voltage of the Y electrode decreases by way of the turning on of the transistor Yfr1, the process where the transistor Yfr1 turns off by way of the voltage reduction of the Y electrode, and the process where the transistor Yfr1 turns on after the turning off thereof are repeated. As those processes are repeated, the gate-source voltage of the transistor Yfr1 is substantially maintained around its threshold voltage. Accordingly, a minute current flows through the transistor Yfr1, and the voltage Vy of the Y electrode is gradually reduced to the Vnf voltage in the ramp pattern, as shown in FIG. 8.

In addition, during the first falling period Tf1, the transistor Yfr1 is substantially maintained in a turned-off state, and the drain voltage of the transistor Yfr2 gradually decreases from the VscH−VscL voltage to 0V. Therefore, during the first falling period Tf1, the drain-source voltage of the transistor Yfr2 gradually decreases from the VscH−VscL voltage to 0V, and accordingly, the power P5 consumed at the transistor Yfr2 during the first falling period Tf1 is given by Equation 5. During the second falling period Tf2, the transistor Yfr2 is maintained in a turned-off state, and the drain voltage of the transistor Yfr1 gradually decreases from the −(VscH−VscL) voltage to the Vnf voltage. Therefore, during the second falling period Tf2, the drain-source voltage of the transistor Yfr1 gradually decreases from the −(VscH−VscL)−Vnf voltage to 0V, and accordingly, the power P6 consumed at the transistor Yfr1 during the second falling period Tf2 is given by Equation 6. Consequently, during the falling period of the reset period, the power P7 consumed at the two transistors Yfr1 and Yfr2 is given by Equation 7.

P5=½*Cp*(VscH−VscL)² [Equation 5]

P6=½*Cp*(VscH−VscL+Vnf)² [Equation 6]

P7=P5+P6=½*Cp*{(Vnf)²+2*(VscH−VscL)*(VscH−VscL+Vnf)} [Equation 7]

By contrast, as shown in FIG. 6, in case the voltage of the Y electrode is gradually reduced from 0V to the Vnf voltage by way of the transistor Yfr, the drain-source voltage of the transistor Yfr gradually decreases from −Vnf to 0V. Therefore, the power P8 consumed through the transistor Yfr is given by Equation 8, and as the VscH−VscL+Vnf voltage is a negative voltage, the power P8 is always greater than the power P7 consumed at the two transistors Yfr1 and Yfr2.

P8=½*Cp*(Vnf)²>P7 [Equation 8]

As the heat dissipation of the transistors Yfr1 and Yfr2 is low, it is possible to use thinner heat sink or omit the heat sink to be attached to the transistors Yfr1 and Yfr2, and accordingly, to reduce the thickness of the plasma display device.

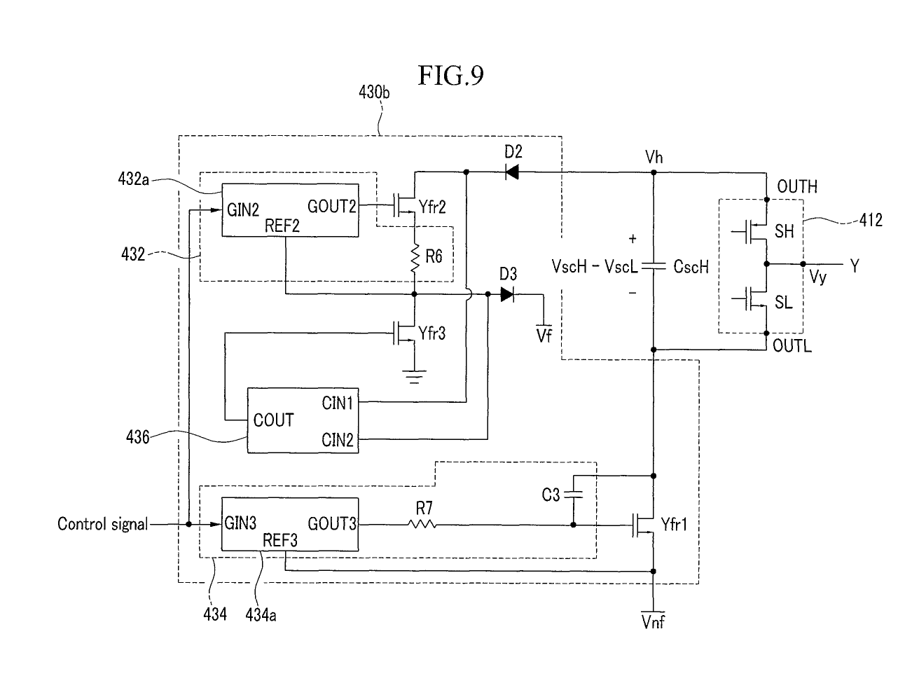

FIG. 9 is a schematic circuit diagram of a falling reset driving circuit 430b according to another exemplary embodiment of the present invention.

Referring to FIG. 9, the falling reset driving circuit 430b further includes a transistor Yfr3, a current interruption element D3, and a comparator 436.

Differing from the falling reset driving circuit 430a shown in FIG. 7, the second terminal of the resistor R6 is connected to the power supply Vf for supplying the Vf voltage, and the transistor Yfr3 is connected between the second terminal of the resistor R6 and the ground terminal. The Vf voltage is lower than the VscH−VscL voltage, and in an embodiment where the Vf voltage is established to be the same as the Verc voltage charged at the capacitor Cerc shown in FIG. 3, the power supply for supplying the Vf voltage may be omitted. In case the source voltage of the transistor Yfr2 is lower than the Vf voltage, the current interruption element D3 may be connected between the resistor R6 and the power supply Vf in order to prevent a current flowing from the power supply Vf to the source of the transistor Yfr2. A diode with an anode connected to the second terminal of the resistor R6 and a cathode connected to the power supply Vf may be used as the current interruption element D3. Alternatively, a transistor may be used as the current interruption element D3.

The drain of the transistor Yfr3 is connected to the second terminal of the resistor R6, and the source thereof is connected to the ground terminal. A resistor may be connected between the gate and source of the transistor Yfr3.

The comparator 436 includes first and second input terminals CIN1 and CIN2, and an output terminal COUT. The first input terminal CIN1 is connected to the drain of the transistor Yfr2 or the high voltage terminal OUTH of the scan circuit 412, and the second input terminal CIN2 is connected to the power supply Vf via the current interruption element D3.

In the first falling period Tf1, when the voltage Vh of the high voltage terminal OUTH is higher than the Vf voltage, the current flows from the Y electrode to the power supply Vf via the transistor SL, the capacitor CscH, the transistor Yfr2, and the resistor R6. Accordingly, the voltage Vh of the high voltage terminal OUTH may gradually decrease from the VscH−VscL voltage to the Vf voltage. Furthermore, the Y electrode voltage Vy gradually decreases from 0V to the −(VscH−VscL−Vf) voltage. In FIG. 9, as the drain-source voltage of the transistor Yfr2 gradually decreases from the VscH−VscL−Vf voltage to 0V, the power P9 given by Equation 9 is consumed during this period.

Thereafter, in the first falling period Tf1, when the voltage Vh of the high voltage terminal OUTH becomes the Vf voltage, the first and second input terminals CIN1 and CIN2 of the comparator 436 become equal in voltage so that the comparator 436 outputs a voltage higher than 0V to the gate of the transistor Yfr3 via the output terminal COUT. Then, the transistor Yfr3 turns on so that the current flows from the Y electrode to the ground terminal via the transistor SL, the capacitor CscH, the transistor Yfr2, the resistor R6, and the transistor Yfr3. Accordingly, the voltage Vh of the high voltage terminal OUTH may gradually decrease from the Vf voltage to 0V. Furthermore, the Y electrode voltage Vy gradually decreases from the −(VscH−VscL−Vf) voltage to the −(VscH−VscL) voltage. In this case, the drain-source voltage of the transistor Yfr2 gradually decreases from the Vf voltage to 0V, and the power P10 given by Equation 10 is consumed during this period.

Thereafter, in the second falling period Tf2, as described above with reference to FIG. 7 and FIG. 8, the Y electrode voltage Vy gradually decreases from the −(VscH−VscL) voltage to the Vnf voltage, and the P6 power given by the Equation 6 is consumed during this period.

Therefore, with the falling reset driving circuit 430b, the P11 power consumed during the falling period is given by Equation 11. As the P11 power given by the Equation 11 is lower than the P7 power given by the Equation 7, the power consumption of the falling reset driving circuit 430b may be reduced even though it has additional elements compared to the falling reset driving circuit 430a.

P9=½*Cp*(VscH−VscL−Vf)² [Equation 9]

P10=½*Cp*(Vf)² [Equation 10]

P11=P9+P10+P6=P5+P6−Cp*Vf*(VscH−VscL−Vf)<P7 [Equation 11]

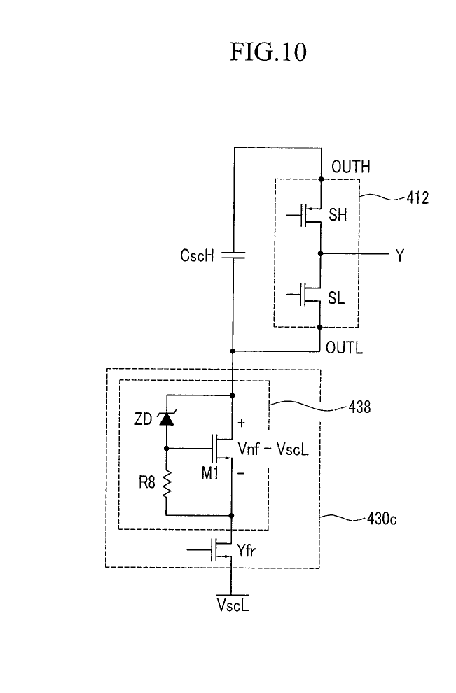

FIG. 10 is a schematic circuit diagram of a falling reset driving circuit 430c according to another exemplary embodiment of the present invention.

As shown in FIG. 10, the falling reset driving circuit 430c further includes a voltage generation circuit 438 connected between the low voltage terminal OUTL of the scan circuit 412 and the power supply VscL for supplying the VscL voltage. The voltage generation circuit 438 includes a transistor M1, a Zener diode ZD, and a resistor R8.

The drain of the transistor M1 is connected to the low voltage terminal OUTL, and the source thereof is connected to the drain of the transistor Yfr. The zener diode ZD is connected between the drain and gate of the transistor M1, and the resistor R8 is connected between the gate and source of the transistor M1.

When the transistor Yfr turns on during the falling period of the reset period so that the current flows from the Y electrode through the transistor Yfr, the current first flows along the zener diode ZD and the resistor R8. Accordingly, when the voltage across the resistor R8 increases so that the transistor M1 turns on, the current flows to the power supply VscL via the two transistors M1 and Yfr. In this case, the drain-source voltage Vds3 of the transistor M1 becomes the sum of the breakdown voltage of the zener diode ZD and a voltage VR across the resistor R8, and is given by Equation 12. In addition, the current flowing along the resistor R8 is determined by the current flowing along the transistor Yfr1 during the falling period. Therefore, when the breakdown voltage Vz of the zener diode ZD and/or the resistor R8 is determined such that the Vz+VR voltage equals the Vnf−VscL voltage, the voltage of the Y electrode is reduced only to the Vnf voltage. In this embodiment, the power supply for supplying the Vnf voltage may be omitted.

Vds3=Vz+VR=Vnf−VscL [Equation 12]

In addition, it is assumed with reference to FIG. 10 that the transistor M1 is an N-channel field effect transistor, but a different type of switch may be used as the transistor M1. Furthermore, it is illustrated in FIG. 10 that the voltage generation circuit 438 is connected to the falling reset driving circuit 430 shown in FIG. 6, but such a voltage generation circuit may be connected to the falling reset driving circuits 430a and 430b shown in FIG. 7 and FIG. 9.

In view of the foregoing, an embodiment of the present invention provides a

a plasma display panel having a first electrode and a second electrode crossing the first electrode, a first driver for driving the first electrode, and a second driver for driving the second electrode and including a first switch and a second switch coupled in series between a first voltage source and the second electrode. The first switch is configured to turn on while the second switch is configured to turn off to increase a voltage level of the second electrode during a first portion of a reset period, and the first switch and the second switch are configured to both concurrently turn on to further increase the voltage level of the second electrode during a second portion of the reset period. Further, according to the embodiment, a connection between the first switch and the second switch is coupled to a second voltage source for applying the connection with a second voltage.

While the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a plasma display panel having a first electrode and a second electrode crossing the first electrode;
a first driver for driving the first electrode; and
a second driver for driving the second electrode and comprising a first switch and a second switch coupled in series between a first voltage source and the second electrode,
wherein the first switch is configured to turn on while the second switch is configured to turn off to increase a voltage level of the second electrode during a first portion of a reset period,
wherein the first switch and the second switch are configured to both concurrently turn on to further increase the voltage level of the second electrode during a second portion of the reset period, and
wherein a connection between the first switch and the second switch is coupled to a second voltage source for applying the connection with a second voltage.

2. The plasma display device in accordance with claim 1, further comprising a third switch between the second electrode and one of the first switch or the second switch and for selectively coupling the second electrode to the one of the first switch or the second switch.

3. The plasma display device in accordance with claim 1, wherein the second voltage has a voltage level between the first voltage and a ground voltage.

4. The plasma display device in accordance with claim 1, wherein the second driver further comprises:
a capacitor for recovering energy during a sustain period and having a first terminal coupled to a ground voltage source and a second terminal coupled to the second electrode.

5. The plasma display device in accordance with claim 4, wherein the second voltage is substantially equal to a voltage across the capacitor.

6. The plasma display device in accordance with claim 1, wherein the first switch is configured to be selectively turned on during the first portion and the second portion of the reset period.

7. The plasma display device in accordance with claim 6, wherein when the first switch is turned on, it is configured to increase the voltage level of the second electrode from a first start voltage to a voltage equal to a sum of the first start voltage and the second voltage.

8. The plasma display device in accordance with claim 6, wherein the first switch is configured to be repeatedly turned on and off during the first portion and the second portion of the reset period.

9. The plasma display device in accordance with claim 6, wherein the first switch and the second switch are configured to be selectively and concurrently turned on during the second portion of the reset period.

10. The plasma display device in accordance with claim 9, wherein when the first switch and the second switch are turned on concurrently, they are configured to increase the voltage level of the second electrode from the voltage equal to the sum of the first start voltage and the second voltage to a voltage equal to a sum of the first start voltage and the first voltage.

11. The plasma display device in accordance with claim 9, wherein the first switch and the second switch are configured to be repeatedly turned on and off during the second portion of the reset period.

12. A method of driving a plasma display device comprising a plasma display panel having a first electrode and a second electrode crossing the first electrode, a driver for driving the second electrode, the driver comprising a first switch and a second switch coupled in series between a first voltage source and the second electrode, wherein a connection between the first switch and the second switch is coupled to a second voltage source for applying a second voltage, in a reset period, the method comprising:
increasing a voltage level of the second electrode from a start voltage to a voltage equal to a sum of the start voltage and the second voltage by turning on the first switch during a first portion of the reset period; and
increasing the voltage level of the second electrode from the voltage equal to the sum of the start voltage and the second voltage to a voltage equal to a sum of the start voltage and the first voltage by concurrently turning on the first switch and the second switch during a second portion of the reset period.

13. The method in accordance with claim 12, wherein the second voltage has a voltage level between the first voltage and a ground voltage.

14. The method in accordance with claim 12, wherein the driver further comprises a capacitor for recovering energy during a sustain period having a first terminal coupled to a ground voltage and a second terminal coupled to the second electrode, the method further comprising:
applying a voltage substantially equal to a voltage across the capacitor as the second voltage.

15. The method in accordance with claim 12, wherein said turning on the first switch comprises:
repeatedly turning on and off the first switch during the first portion of the reset period.

16. The method in accordance with claim 12, wherein said concurrently turning on the first switch and the second switch comprises:
repeatedly turning on and off the first switch and the second switch during the second portion of the reset period.

17. A plasma display device comprising:
a plasma display panel having a first electrode and a second electrode crossing the first electrode; and
a driver for driving the second electrode and comprising:
a first switch coupled between the second electrode and a first voltage source for applying a first voltage; and
a second switch coupled between the second electrode and a second voltage source, the second voltage source for applying a second voltage lower in voltage level than the first voltage;
wherein the first switch is configured to decrease a voltage level of the second electrode from the first voltage to a third voltage having a voltage level between the second voltage and the first voltage during a first portion of the reset period, and the second switch is configured to further decrease the voltage level of the second electrode from the third voltage to the second voltage during a second portion of the reset period.

18. The plasma display device in accordance with claim 17, wherein the first switch is configured to be selectively turned on during the first portion of the reset period to decrease the voltage level of the second electrode from the first voltage to the third voltage.

19. The plasma display device in accordance with claim 18, wherein the first switch is configured to be repeatedly turned on and off during the first portion of the reset period.

20. The plasma display device in accordance with claim 18, wherein the second switch is configured to be selectively turned on during the second portion of the reset period to decrease the voltage level of the second electrode from the third voltage to the second voltage.

21. The plasma display device in accordance with claim 20, wherein the second switch is configured to be repeatedly turned on and off during the second portion of the reset period.

22. The plasma display device in accordance with claim 17, further comprising:
a third switch coupled between the first switch and the first voltage source,
wherein a connection between the first switch and the third switch is applied with a fourth voltage higher in voltage level than the first voltage.

23. The plasma display device in accordance with claim 22, further comprising:
a capacitor for recovering energy during a sustain period having a first terminal coupled to the first voltage source and a second terminal coupled to the second electrode,
wherein the fourth voltage is substantially equal to a voltage across the capacitor.
